(19) United States
(12) Patent Application Publication
(10) Pub. No.: US 2019/0077292 A1
(43) Pub. Date: Mar. 14, 2019

(54) OVERFILL PREVENTION SYSTEM PROBE TANKS FOR TRANSPORT OF LIQUID FUELS AND CORRESPONDING OVERFILL PREVENTION SYSTEM

(71) Applicant: INTERSENS, Paris (FR)

(72) Inventor: Bruno Morel-Fatio, Paris (FR)

(73) Assignee: INTERSENS, Paris (FR)

(21) Appl. No.: 16/129,493

(22) Filed: Sep. 12, 2018

(30) Foreign Application Priority Data
Sep. 13, 2017 (FR) 1758479
Jan. 16, 2018 (FR) 1850350

(51) Int. Cl. B60P 3/22; B67D 7/32

(52) U.S. Cl. CPC B60P 3/228; B60P 3/225; B60P 3/2265; B67D 7/3218; B60P 3/2245

(57) ABSTRACT

This overfill prevention system probe for tanks for transport of liquid fuels comprises a level detector mounted on a support that is fixed to the tank so that the detector is placed in the compartment at a maximum permissible filling height. The level detector includes a measuring sensor comprising a set of several electrodes and means for measuring the dielectric permittivity of a fluid present between the electrodes. The probe also comprises means for testing the satisfactory operation of the entire acquisition chain of the dielectric permittivity measurement of the fluid present at the electrodes.

### BACKGROUND

Worldwide, the great majority of such systems must meet CEN European standard EN 13922, which ensures in particular interoperability between the probes of the tank vehicle and the loading device. To prevent explosive hazardous substances from overflowing during the filling phase, a probe is placed in the upper part of each compartment of the tank vehicle. The status of the probe changes when it gets wet. It is connected to the loading device so that it immediately stops the filling process when wetting is detected.

In order to limit filling, the use of probes based on the implementation of a thermistor that detects a temperature differential when the probe comes into contact with the product was initially proposed.

However, it was noted that this type of thermistor-based technology was too fragile and led to excessively frequent replacements of the probes.

Detection of the fuel level in each compartment of the tank vehicle, during the filling thereof, using probes based on an optical principle of variation of the refraction angle of a light beam, has also been proposed. These probes use a cone made from transparent material, for example polypropylene, which reflects a non-divergent light beam emitted by a light-emitting diode, and including a receiver that detects the reflected light. The cone is positioned at an overflow detection level. Thus, when the liquid level reaches the detection level of the probe, the refractive index of the cone is changed and the light is no longer detected.

There are however many drawbacks to this type of technology.

Firstly, the angle of refraction of the light beam depends on a very small contact surface, which receives the light beam, in the order of a few mm in diameter. If, for example, a bubble is present at this point of contact, the direction of the beam is disrupted.

Secondly, the light beam can be reflected uncontrollably by metal surfaces within the compartment. For example, light beam scattering devices recently had to be added at the bottom of fraud protection sheaths to prevent undesirable reflections on these sheaths.

It was also noted that the optical characteristics of the transparent cone tend to deteriorate over time, for example by opacification or the appearance of micro cracks, so that over time the function of the transparent cone tends to deteriorate.

In addition, the light energy of the light-emitting diodes decreases over time and when the temperature increases. This phenomenon is well known to optical probe manufacturers. When the temperature exceeds 60° C., satisfactory operation is no longer guaranteed and the life of the product is shortened.

Finally, the energy required by a light-emitting diode to emit a light beam is intrinsically high, and is hardly compatible with the “intrinsic safety” constraints required in explosive atmospheres that limit electrical energy to extremely low levels to ensure the absence of sparks and hot spots. Sufficient light intensity is difficult to achieve, particularly when the performance of the diodes has deteriorated.

### SUMMARY

The aim of the disclosure is to propose an overfill prevention system probe for tanks for transport of liquid fuels that overcomes these various drawbacks.

According to a second aspect, a further object of the disclosure is an overfill prevention system for tanks for transport of liquid fuels, comprising a probe assembly as defined above, for detecting a filling level in a set of compartments, and a filling controller receiving a filling authorization signal emitted by each probe, to control pump and valve type actuators of a filling controller.

### DESCRIPTION OF THE DRAWINGS

Further aims, features and advantages of the disclosure will become apparent on reading the following description, given as a non-limitative example with reference to the attached drawings, in which:

FIG. 1 is a diagrammatic view of a compartment equipped with an overfill prevention system according to the disclosure;

FIG. 2 is a block diagram of an embodiment of a probe according to the disclosure;

FIG. 3 is a perspective diagrammatic view of an embodiment of a probe according to the disclosure; and

FIG. 4 illustrates another embodiment of a probe according to the disclosure.

### DETAILED DESCRIPTION

The present disclosure essentially relates to the transportation of liquid petroleum fuels, and more particularly relates to overfill prevention systems for tanks for transport of liquid fuels. A particular object of the disclosure is an overfill prevention system for implementation during the filling of tanks.

According to a first aspect, the object of the disclosure is therefore an overfill prevention system probe for tanks for transport of liquid fuels, comprising a level detector mounted on a support that is fixed on the tank so that the detector is placed in the compartment at a maximum permissible filling height.

The level detector includes a measuring sensor comprising a set of several electrodes and means for measuring the dielectric permittivity of a fluid present between the electrodes.

The probe according to the disclosure thus makes it possible to ensure three-dimensional measurement of the liquid level due to the electrodes, which are advantageously embodied by parallel plates, and not one-dimensional measurement as is the case when using an optical sensor, with a high level of reliability.

For example, the level detection may be based on a comparison between the dielectric permittivity measurement either of the ambient gas (non-wetted sensor) or of the liquid being filled (wetted sensor).

The probe includes means for testing the satisfactory operation of the entire acquisition chain of the dielectric permittivity measurement of the fluid present at the electrodes. Means for comparing the measurement obtained with threshold values are implemented.

According to one feature of the disclosure, the means for testing the operation of the acquisition chain comprise means for deterministically and periodically modifying the capacitance value measured by the detector and means for comparing the value of the modified measurement with a threshold value.

For example, the means for testing the operation of the acquisition chain comprise means for periodically connecting at least one calibration capacitor to the electrodes.

Advantageously, the means for testing the operation of the acquisition chain are automatic testing means.

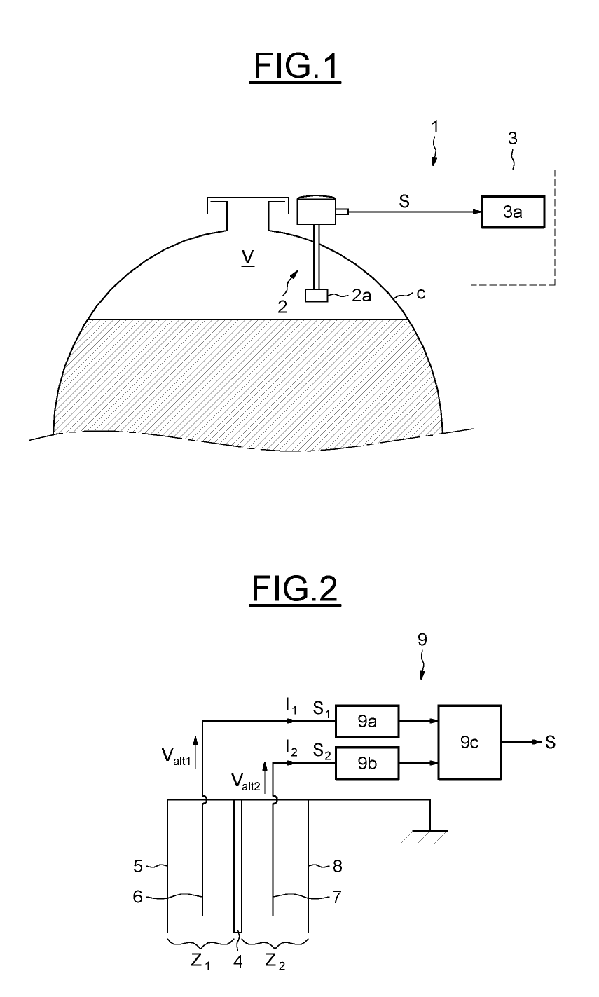

The compartment C illustrated in FIG. 1 is, for example, a compartment of a tank vehicle, used for transporting liquid petroleum fuel.

In the embodiment illustrated in FIG. 1, only one compartment has been shown. Such a tank may have one to nine compartments of variable size.

As can be seen, each compartment C is equipped with an overfill prevention system in order to detect any risk of overflow by detecting the filling of the compartment up to a maximum permissible filling height that, advantageously, defines a safety stowage volume V, for example in the order of a hundred liters.

Such a stowage volume makes it possible to take into account the stopping times of the pumps and valves of a filling system, when the maximum height is reached, in order to prevent any risk of overflow.

The overfill prevention system, denoted by general numerical reference sign 1, includes, for each compartment, a level detector made up of a probe 2 that detects the maximum filling level in the compartment C and is connected to a device 3 for loading tanks for transport of liquid fuels provided at the tanker truck loading bay, comprising a filling controller 3a made up of a probe analyzer incorporated into the loading device for controlling the tank loading device on the basis of the signals from the probes 2.

The probe 2 comprises a level sensor 2a including electrodes and means for measuring the dielectric permittivity of the fluid between the electrodes.

However, the probe 2 visible in FIG. 2 is a multizone probe and therefore ensures independent, redundant impedance measurements.

The probe 2 thus includes several sets of electrodes in the form of independent sets of metal plates, two here, separated by a common separating electrode 4, formed by one of the plates, and delimiting two zones Z1 and Z2. In the embodiment illustrated in FIG. 2, the probe thus includes two redundant level measuring assemblies, each formed by a set of metal plates each associated with means of measuring the dielectric permittivity between the plates. Of course, a larger number of detection zones may be used to increase the number of redundant level measurements.

Each zone Z1 or Z2 contains three metal plates 5, 6 and 4, on one side, and 4, 7 and 8, on the other.

These plates are apart from one another so that volumes of fluid, gas or liquid, can flow between them.

Each fluid has a specific dielectric permittivity relative to a vacuum (εr).

For example, the permittivity of air is 1.0005. The permittivity of oil or petroleum products is greater than 2. The permittivity of alcohol is greater than 6. Finally, the permittivity of water is greater than 30.

The value of the capacitor formed by the facing parallel plates is given by the equation:

C=εr×(S/e)

Where:

S=area of the conducting plates in m²; and

e=distance between the plates in m.

The value of the capacitor formed by each pair of plates is given in farads. Thus, depending on the geometry of the electrodes, an impedance that is the image of the dielectric permittivity of the medium in which the electrodes are located is measured.

The arrangement of the sets of facing electrodes separated by the separating plate 4 makes it possible to create independent groups of measurement capacitors providing measurements that are themselves independent.

The probe 2 comprises a computing device 9 incorporating the independent impedance measuring sensors. It retrieves the real and imaginary parts of the impedances of the fluid present in zones Z1 and Z2 and compares them with threshold values.

As can be seen, the computing device 9 includes two independent central units 9a and 9b each ensuring, in parallel, the processing of the independent impedance measurement signals S1 and S2. The processed signals are supplied to a comparator 9c that ensures the correlation between the impedance values supplied. It must in particular be checked that the deviation between the impedance values obtained for each zone does not exceed a threshold limit value beyond which the level measurement is regarded as invalid.

When the probe detects the presence of a fluid the dielectric permittivity of which corresponds to that of a liquid and not that of a gas, the computing device 9 updates the level with a filling authorization or prohibition signal S sent to the filling controller 3a.

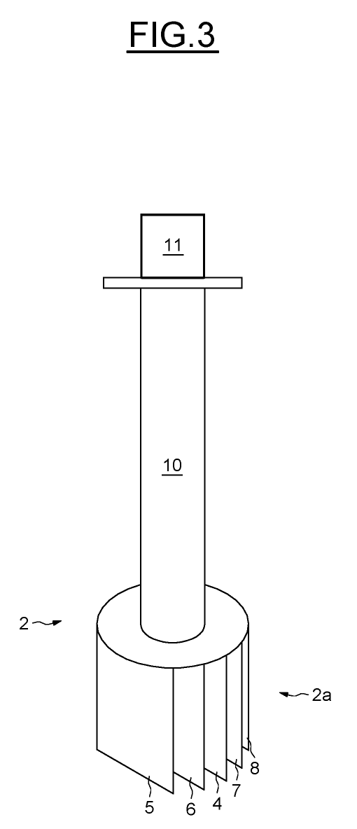

Finally, FIG. 3 is a diagrammatic view of an embodiment of a probe according to the disclosure.

In this figure, the two sets of plates 5, 6, 7 and 8 separated by the separating plate 4 can be seen.

These two sets of plates are mounted on a tubular support 10, itself topped by a head 11 serving as a connecting relay for linking the probe with the filling controller 3a.

For example, the central unit may take the form of an electronic board mounted inside the tube 10.

A cylindrical cover (not shown) that allows the fluid through surrounds the sets of plates to protect them mechanically.

As shown in FIG. 1, the assembly is mounted on the tank, through a hole made in the upper part of wall thereof, so that the detector, and in particular the electrodes, are placed at the maximum permissible filling height.

It will however be noted that the disclosure is not limited to the embodiment described above with reference to FIGS. 1 to 3.

Whereas in the embodiment described above, the probe 2 is a multizone probe including several sets of electrodes in the form of independent sets of metal plates that therefore provide independent, redundant impedance measurements, it will be noted that the performance of a non-redundant level measurement by the probe does not fall outside the scope of the disclosure.

Thus, according to another aspect, the probe ensures a single level measurement.

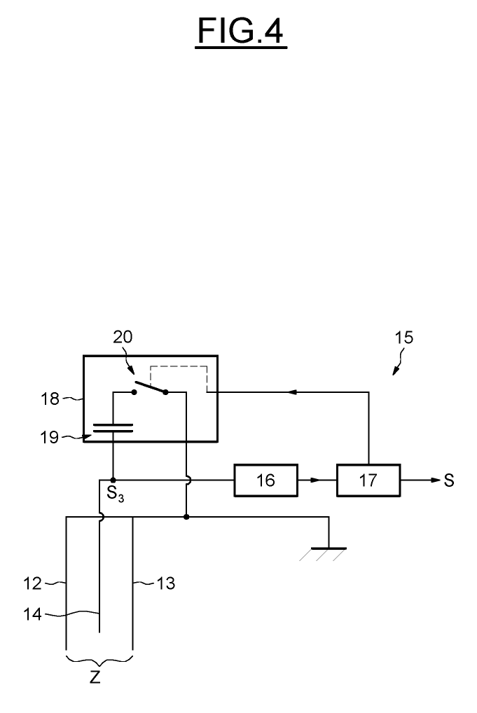

FIG. 4 shows such an embodiment.

Here, the probe 2 includes a single set of electrodes in the form of metal plates, three here, with reference signs 12, 13 and 14, which ensure a measurement in a single zone Z. The probe is connected to a computing device 15 that, as in the embodiment described above, retrieves the real and imaginary parts of the impedance of the fluid present in the zone Z and compares them with a threshold value.

The computing device 15 incorporates means 16 for measuring the dielectric permittivity of the fluid present between the electrodes, which retrieve the signal S3 supplied by the plates and ensure the processing of this signal for measuring the impedance of the fluid between the electrodes. The processed signal is supplied to a central unit 17 that compares the dielectric permittivity measurement with one or more thresholds, in order to determine whether the fluid present between the electrodes is a liquid or a gas.

The central unit 17 updates the level with a filling authorization or prohibition signal S sent to the filling controller 3a (FIG. 1).

Advantageously, such a probe is supplemented by means 18 for testing the operation of the acquisition chain of the measurement made by the probe, comprising the electrodes and the measuring means 16.

These testing means 18 are intended for the dynamic, periodic and automated application under the control of the central unit 17, to the source of the measurement, namely the electrodes, of a reference calibration element capable of deterministically modifying the measurement. The central unit then compares the modified permittivity measurement with a threshold value to check the satisfactory operation of the acquisition chain.

As can be seen, the testing means 18 are embodied in the form of one or more capacitors 19, selectively connected between the electrodes 13 and 14 by means of a switch 20 controlled by the central unit 17.

If the measurement obtained during the connection of the capacitor is not equal to an expected value, which corresponds to the empty value increased by a known value from the calibration capacitor, the central unit deduces that at least one element of the acquisition chain of the probe does not comply with the expected specifications. The probe is then placed in “fault” mode and the tank loading device is switched to safety mode by deactivation of the filling authorization or prohibition signal S sent to the filling controller 3a.

Of course, such an embodiment could also be envisaged in probes wherein the level measurements are redundant.

While illustrative embodiments have been illustrated and described, it will be appreciated that various changes can be made therein without departing from the spirit and scope of the invention.

The embodiments of the invention in which an exclusive property or privilege is claimed are defined as follows:

1. An overfill prevention system probe for tanks for transport of liquid fuels, comprising a level detector mounted on a support that is fixed on the tank so that the detector is placed in the compartment at a maximum permissible filling height, characterized in that the level detector includes a measuring sensor including a set of several electrodes and means for measuring the dielectric permittivity of a fluid present between the electrodes, the probe comprising means for testing the satisfactory operation of the entire acquisition chain of the dielectric permittivity measurement of the fluid present at the electrodes.

2. The probe according to claim 1, wherein the means for testing the operation of the acquisition chain comprise means for deterministically and periodically modifying the capacitance value measured by the detector and means for comparing the value of the modified measurement with a threshold value.

3. The probe according to claim 1, wherein the means for testing the operation of the acquisition chain comprise means for periodically connecting at least one calibration capacitor to the electrodes.

4. The probe according to claim 3, wherein the means for testing the operation of the acquisition chain are automatic testing means.

5. An overfill prevention system for tanks for transport of liquid fuels, comprising a probe assembly according to claim 1, for detecting a filling level in a set of compartments, and a filling controller receiving a filling authorization signal emitted for each probe, to control pump and valve type actuators of a filling controller.
